(19) United States
(12) Patent Application Publication
(10) Pub. No.: US 2010/0124477 A1
(43) Pub. Date: May 20, 2010

(54) Electric Platform System

(76) Inventor: Chiu-Kuei Wang, Taichung County (TW)

Correspondence Address: DAVID AND RAYMOND PATENT FIRM, 108 N. YNEZ AVE., SUITE 128, MONTEREY PARK, CA, 91754, US

(21) Appl. No.: 12/617,666

(22) Filed: Nov. 12, 2009

(30) Foreign Application Priority Data
Nov. 14, 2008 (TW) 097144006

(51) Int. Cl. B60R 9/06

(52) U.S. Cl. 414/462

(57) ABSTRACT

An electric platform system includes a link unit pivotably connected between a connection member on the vehicle and a support link. The link unit includes multiple links and the support link. A support board is pivotably connected the support link and the support board can be pivoted upward when not in use. A driving unit is connected to the link unit and drives the link unit up and down to adjust the position of the support board. Two stop links are connected to the connection member and the support board. The two stop links have inclined surfaces which contact a side of the support board when pivoting the support board upward.

### FIELD OF THE INVENTION

The present invention relates to an electric platform system, and more particularly, to an electric platform system which is foldably connected to a vehicle and can be lifted, lowered and pivoted for convenience of carriage and release of electric cart.

### BACKGROUND OF THE INVENTION

Electric carts are designed for elders or disables which include an electric motor which drives the cart usually have four wheels and the cart can be easily operated by operation of handlebars. The electric carts allow the elders or disables to feel free to go outside without need of high standard of physical conditions. In order to carry the electric cart on a vehicle, an electric platform is developed which is connected to the hitch on the vehicle and the platform can be lifted or lowered such that the electric cart can be positioned on the platform and transported to a destination at distance.

As shown in FIGS. 9, 10, 11A and 11B, the conventional electric platform system is connected to a support link 76 which is connected with a connection member 70 which is connected to the vehicle. A connection unit 77 is used to connect the support link 76 and the platform 80 by multiple plates 78 of the connection unit 77 and the rods 81 on the platform 80. The platform 80 can be pivoted upward about the pins connecting the multiple plates 78 and the rods 84 as shown in FIG. 11B. The support link 76 is retractably inserted into the tube 73 so as to adjust the position of the platform 80. A control box 75 is connected to the top of the tube 73 so as to operate the support link 76. The connection member 70 is connected to an upright rod 72 which is connected to the frame 74 connected to the tube 73. The electric cart can be fixed on the platform 80 and conveniently carried to distanced destinations. The platform cart does not occupy the interior space of the vehicle. The platform 80 is pivoted upward as shown in FIG. 11B so as to reduce the depth required when parking.

Some electric platforms are cooperated with a swing device which allows the platform to be swung aside such that the rear door of the vehicle can be opened while the whole electric platform does not need to be removed or disengaged from the vehicle. However, the swing device can only be operated manually and which obviously is not convenient for most of the users. Some electric platforms are cooperated with a system that receives the electric cart into the vehicle so that the electric cart is not exposed outside of the vehicle. Nevertheless, the system is complicated and occupies the interior space in the vehicle. Besides, because the system is located in the vehicle, the maintenance will be difficult due to the small space available in the vehicle.

US 2009/020577A1 discloses a hitch-mounted device which includes a fork unit driven by a hydraulic system and the fork unit is connected with a link unit which allows the fork unit to be move up and down when the hydraulic system is activated. The fork unit can only lift or lower objects in vertical direction and is not suitable for the user of the electric cart and the electric platform for carry the electric cart.

The present invention intends to provide an electric platform system which includes a link unit, a driving unit, a support board, the support board can be adjusted in vertical direction for carry and release the electric cart. The support board is also be pivoted upward by the driving unit and the link unit to save space when parking the vehicle.

### SUMMARY OF THE INVENTION

The present invention relates to an electric platform system which includes a link unit pivotably connected between a connection member on the vehicle and a support link. The link unit includes multiple links and the support link. A support board is pivotably connected the support link and the support board can be pivoted upward when not in use. A driving unit is connected to the link unit and drives the link unit up and down to adjust the position of the support board. Two stop links are connected to the connection member and the support board. The two stop links have inclined surfaces which contact a side of the support board when pivoting the support board upward.

The primary object of the present invention is to provide an electric platform system wherein the support board can be lifted or lowered by operation of the link unit and the driving unit.

Another object of the present invention is to provide an electric platform system wherein the whole electric platform system can be lowered to a position that is lower then a lower edge of the rear door of the vehicle, such that the rear door can be opened.

Yet another object of the present invention is to provide an electric platform system which includes two stop links which contact one side of the support board to assist the pivotal action of the support board.

A further object of the present invention is to provide an electric platform system which includes a locking member to lock the link unit and the support link when the support board is positioned in upward position.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the electric platform system of the present invention;

FIG. 2 is an exploded view to show the electric platform system of the present invention;

FIG. 3A is a perspective view to show that the link unit expands to lower the support board of the present invention;

FIG. 3B is a perspective view to show that the electric cart is to be moved onto the support board of the present invention;

FIG. 3C is a perspective view to show that the electric cart is moved onto the support board and securely positioned by two straps;

FIG. 4A shows that the pin is removed from the stop link and the link unit is to be folded;

FIG. 4B shows that stop links are pivoted downward;

FIG. 5A is a side view to show that the pin is inserted into stop link and the slot of the restriction member;

FIG. 5B is a side view to show that the driving member is extended to pivot the link unit upward;

FIG. 5C is a side view to show that the second inclined surfaces of the stop links contact the support board when the support board is pivoted upward;

FIG. 5D is a side view to show that the first inclined surfaces of the stop links contact the support board when the support board is positioned at the upright position;

FIG. 6 shows that a locking member is connected to the support link;

FIG. 7 is a side view to show that the locking member locks the support link and the link unit when the support board is positioned at the upright position;

FIG. 8 shows that the support board is fully expanded and positioned at the lower position;

FIG. 9 is a side view to show a conventional electric platform system on a rear end of a vehicle;

FIG. 10 is a perspective view of the conventional electric platform system;

FIG. 11A shows that the platform of the conventional electric platform system is to be pivoted upward, and

FIG. 11B shows that the platform of the conventional electric platform system is positioned at the upright position.

### DETAILED DESCRIPTION OF THE PREFERRED EMBODIMENT

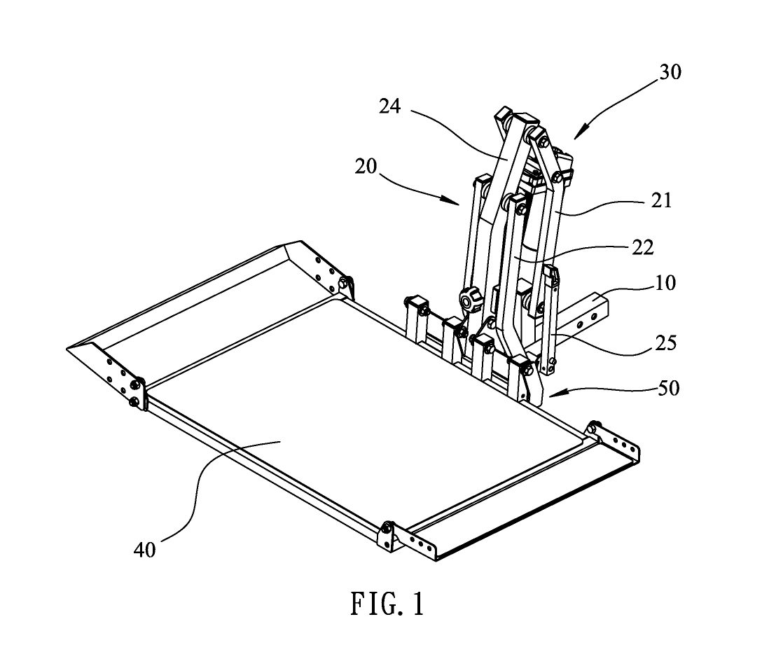

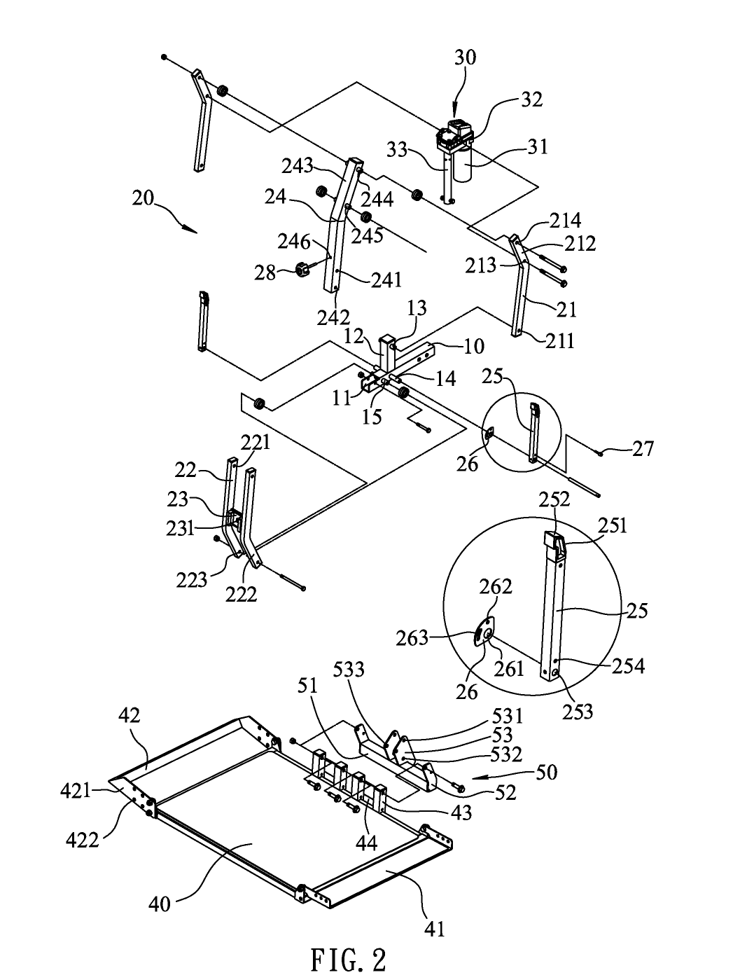

Referring to FIGS. 1 and 2, the electric platform system of the present invention comprises a connection member 10 having a first end connected to a vehicle and a second end of the connection member 10 is connected with a link unit 20. A recess 11 is defined in the second end of the connection member 10. An upright portion 12 perpendicularly extends from the connection member 10 and two first rod 13 extend from two sides of the upright portion 12. Two second rods 14 and two second rods 15 extend from two sides of the connection member 10.

The link unit 20 includes first links 21, second links 22 and a support link 24. The first links 21 each includes a first hole 211 through which the first rod 13 extend so as to be pivotably connected between two sides of the connection member 10. Each of the first links 21 further includes a first inclined section 212 which is pivotably connected to the support link 24. A second hole 213 is defined through each of the first links 21 and a third hole 214 is defined through the first inclined section 212 of each of the first links 21. Each of the second links 22 includes a first bore 221 in one end thereof and a second inclined section 222 extends from the other end of each second link 22. The second inclined section 222 includes a second bore 223 to which the third rod 15 on the connection member 10 is pivotably connected. A bridge member 23 is connected between the two second links 22 and includes a fixing hole 231.

The support link 24 includes a first aperture 241 and a second aperture 242 defined therethrough. A third inclined section 24 is connected to an end of the support link 24 and two first side rods 244 and two second side rods 245 extend from two sides of the third inclined section 24. The third holes 214 of the first links 21 are mounted to the first side rods 244. The first bores 221 of the second links 22 are mounted to the second side rods 245 of the support link 24.

Two stop links 25 are connected to the connection member 10 and the support board 40, wherein the stop links 25 each have a first inclined surface 251 and a second inclined surface 252 which is located adjacent to the first inclined surface 251. A passage 253 is defined through each stop link 25 and located at a remote end from the first and second inclined surfaces 251, 252. A hole 254 is defined through each stop link 25 and located above the passage 253.

A restriction member 26 is a quarter of a circular plate and located between the connection member 10 and one of the stop links 25. The restriction member 26 includes a pivot hole 261, positioning hole 262 and a slot 263 defined therethrough. One of the second rod 14 on the connection member 10 extends through the pivot hole 261 of the restriction member 26 and the passages 253 of the two stop links 25 are mounted to the two second rods 14. A pin 27 extends through the hole 254 of the stop link 25 and the positioning hole 262 of the restriction member 26.

A driving unit 30 is connected to the link unit 20 and drives the link unit 20 up and down. The driving unit 30 includes a motor 31 and a driving rod 33, a connection part 32 connects the motor 31 and the driving rod 33. The driving rod 33 is driven by the motor 31 and connected to the connection member 10. The connection part 32 is connected to the second holes 213 of the first links 21 so that the motor 31 is located between the two first links 21. The driving rod 33 is connected to the recess 11 of the connection member 10.

The support board 40 includes an entry plate 41 on one end and a side part 42 on the other end of the support board 40, wherein the side part 42 is a U-shaped board and multiple positioning holes 422 are defined through two sidewalls thereof so that the side part 42 can be adjusted relative to the support board 40 by connecting the support board 40 at different positioning holes 422. Multiple protrusions 43 extend from one side of the support board 40 and two push plates 44 are connected between the protrusions 43. A connection frame 50 is connected between the support link 24 and the support board 40, and includes a main part 51 and two end plates 52 which are connected on two ends of the main part 51. Multiple connection plates 53 are connected to the main part 51 and the support link 24 is pivotably connected between the connection plates 53. The end plates 52 and the connection plates 53 are pivotably connected to protrusions 43 on the support board 40. Each of the connection plates 53 includes first, second and third connection holes 531, 532, 533. The first and second apertures 241, 242 of the support link 24 are respectively and pivotably connected to the first ands second connection holes 531, 532 of the connection plates 53. The end plates 52 and the third connection holes 533 of the connection plates 53 and the protrusions 43 on the support board 40 are connected to each other by a bolt.

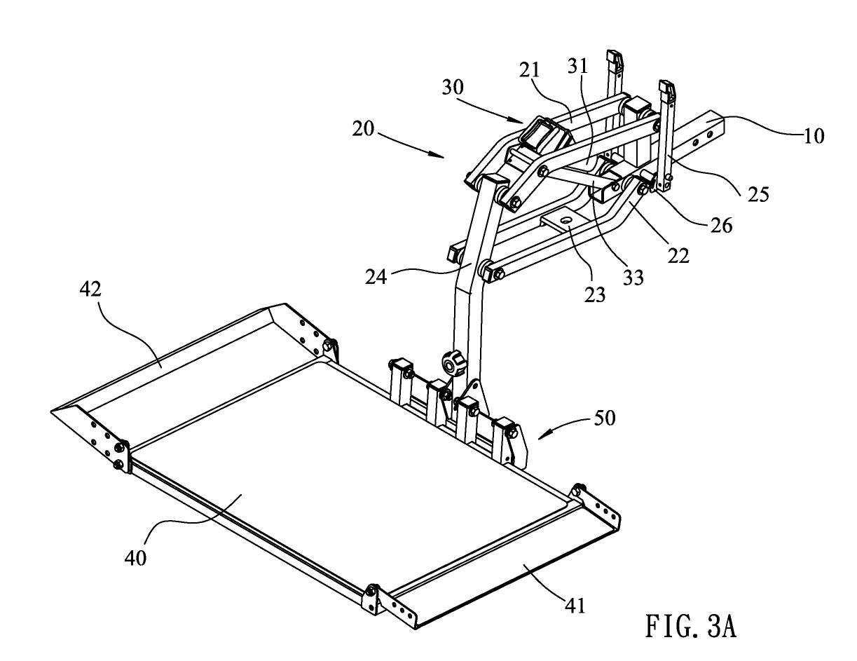

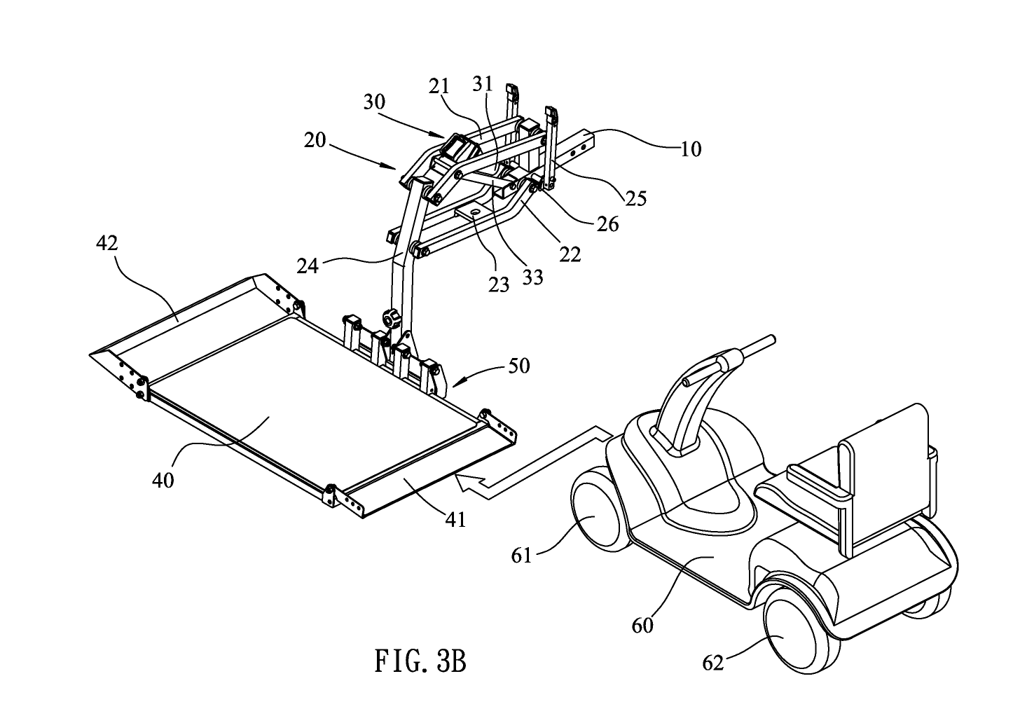

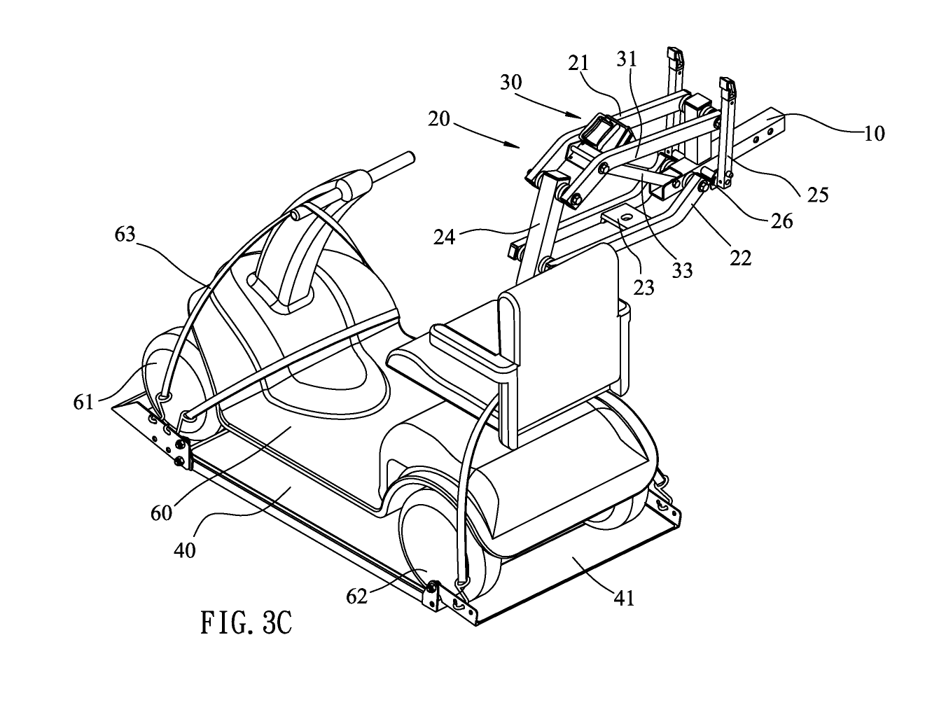

As shown in FIGS. 3A to 3C, when the driving unit 30 is activated to drive the link unit 20 to lower the support link 24 and the support board 40, the entry plate 41 is located close to the ground so that the electric cart 60 can easily move onto the support board 40 via the entry plate 41. The first wheels 61 of the electric cart 60 are positioned in the space between the side part 40 and the support board 40. The entry plate 41 is then pivoted upward to stop the second wheels 62 of the electric cart 60. Two straps are used to securely position the electric cart 60 on the support board 40.

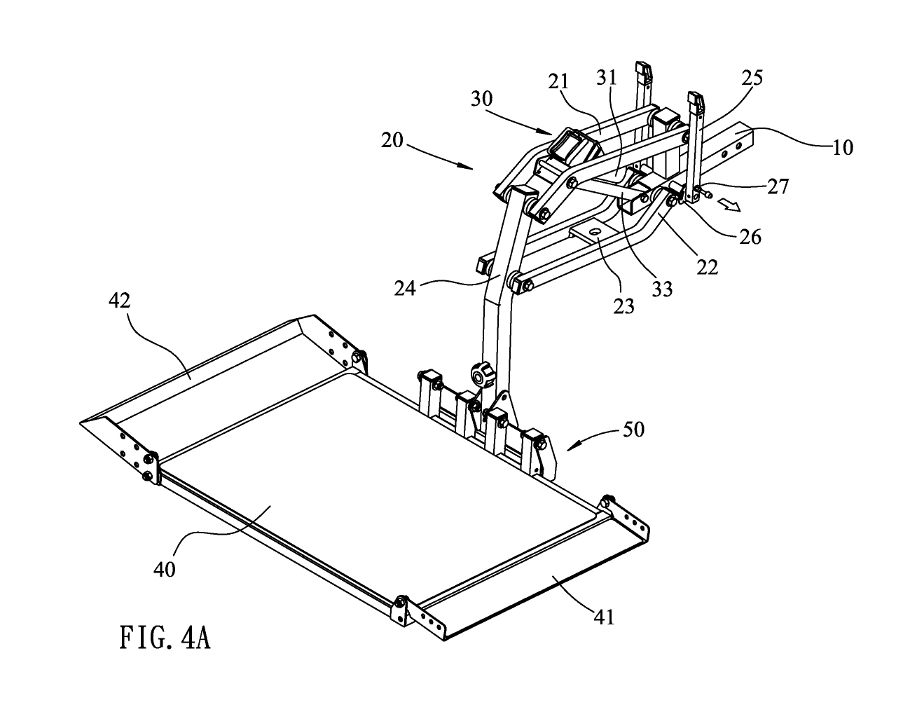

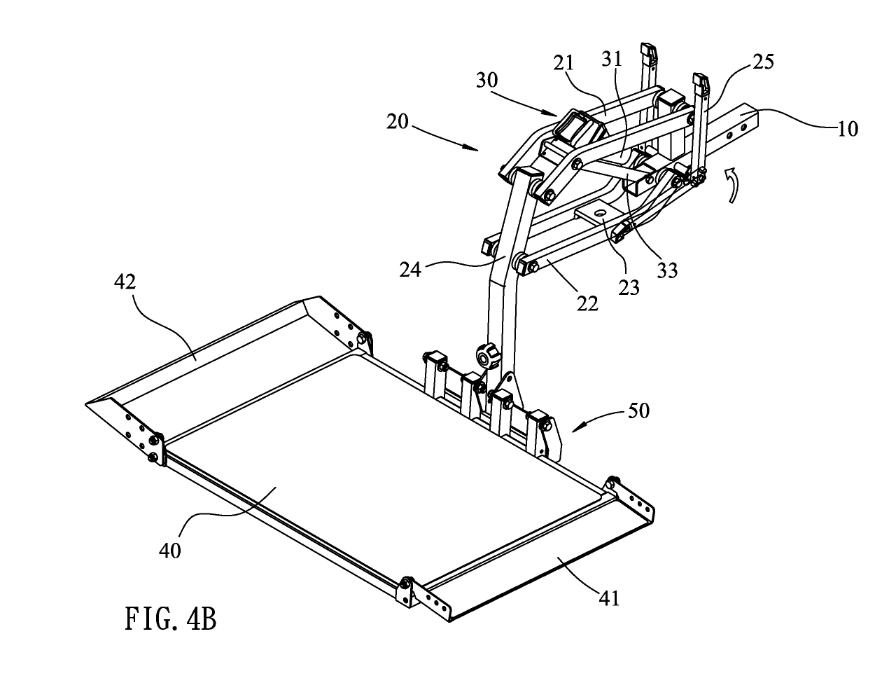

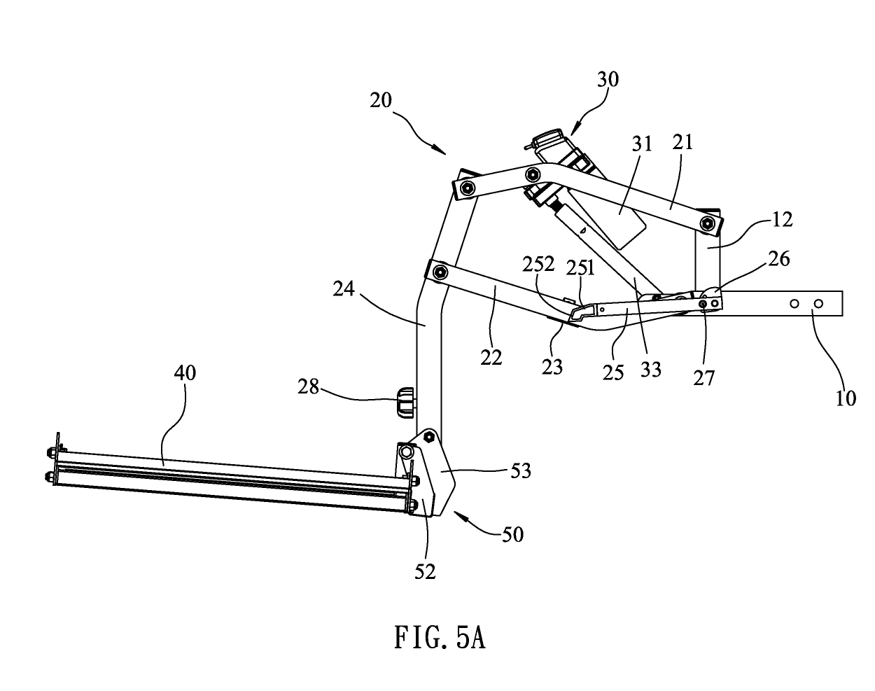

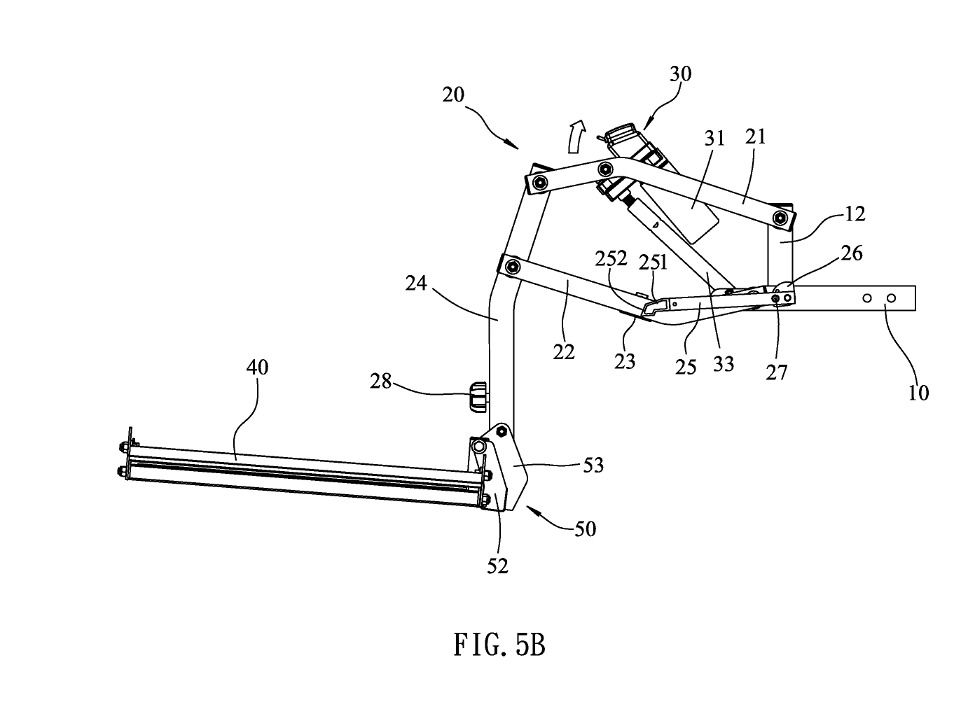

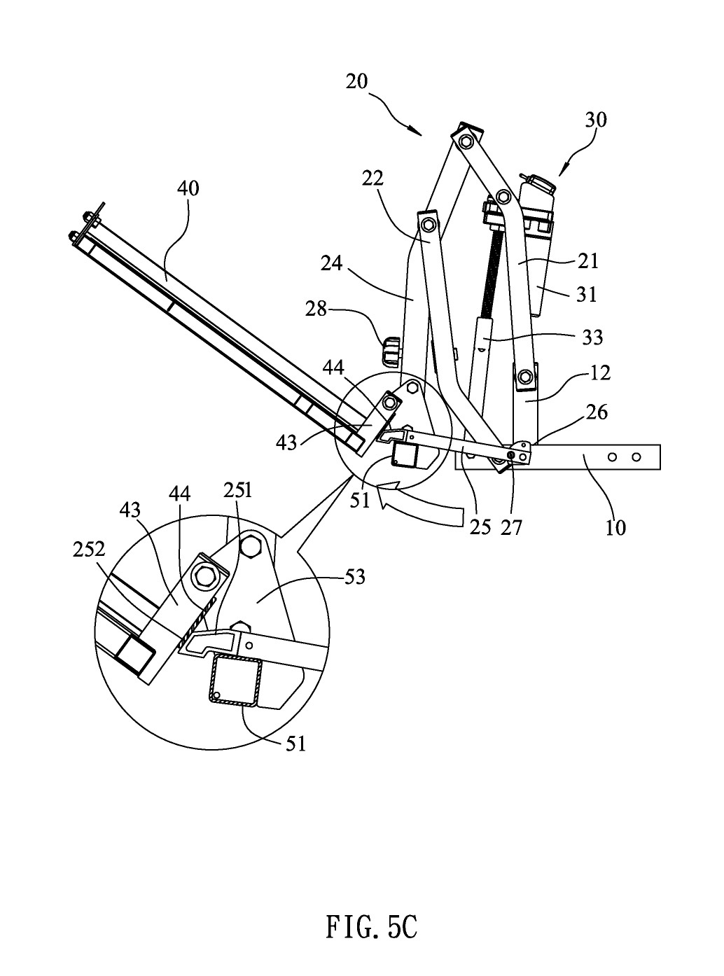

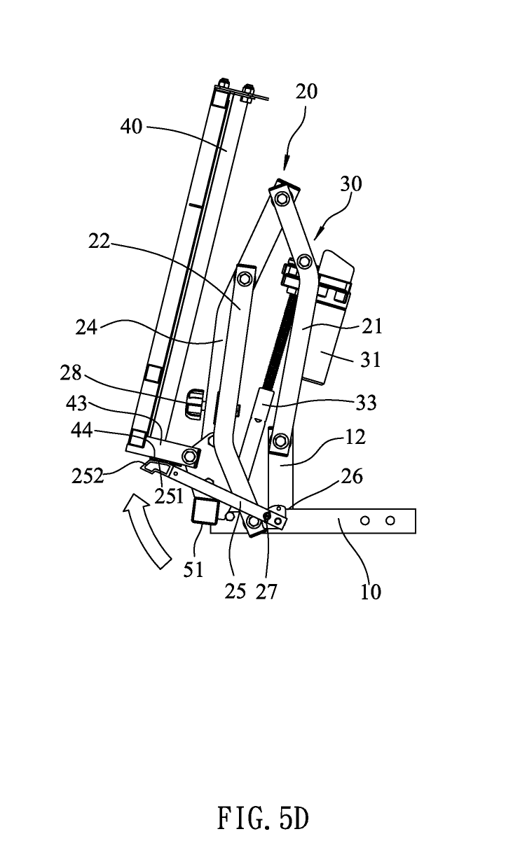

Referring to FIGS. 4A, 4B, and 5A to 5D, when the electric cart 60 is removed the support board 40, the support board 40 can be folded. The pin 27 is first removed from the positioning hole 262 of the restriction member 26, and the two stop links 25 are pivoted downward and the pin 27 is inserted into the slot 263 of the restriction member 26. The driving rod 33 extends downward and moves the link unit 20 upward to raise the support link 24 and the support board 40 by the first and second links 21, 22. The second inclined surfaces 252 of the stop links 25 are now in contact with the push plate 44 of the support board 40. The driving rod 33 and the link unit 20 continue to move, because the second inclined surfaces 252 of the stop links 25 are in contact with the push plate 44 of the support board 40, and the stop links 25 are restricted to move within the slot 263 in the restriction member 26, so that the support board 40 can be pivoted upward. When the support board 40 is pivoted to its upright position, the first inclined surfaces 251 are in contact with the push plates 44.

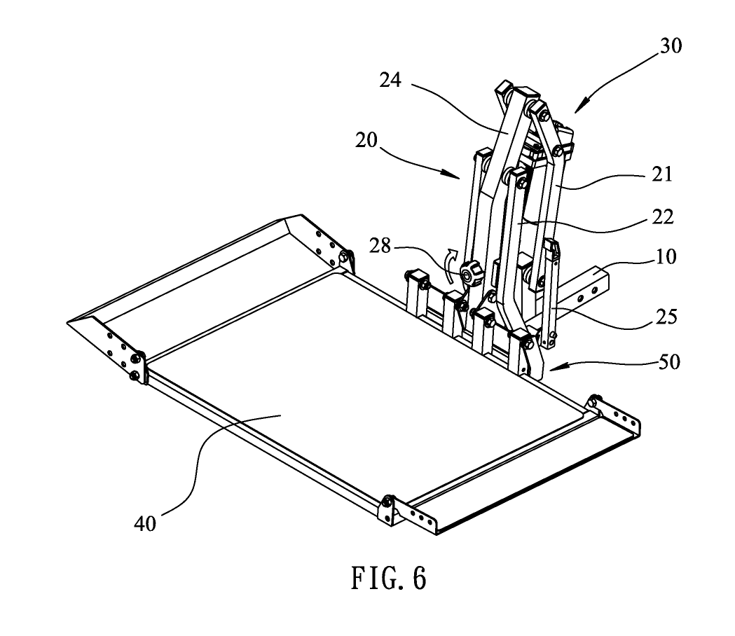

As shown in FIGS. 1 and 6, a through hole 246 (FIG. 1) is defined through the support link 24 and a locking member 28 extends through the through hole 246 of the support link 24 and the fixing hole 231 of the bridge member 23 to lock the support link 24 and the link unit 20 when the support board 40 is folded upward.

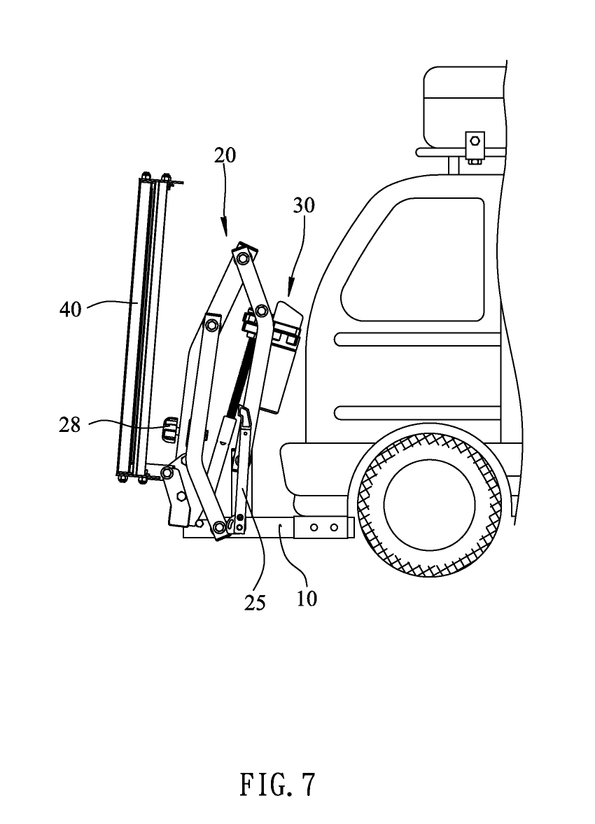

FIG. 7 shows that the electric platform system is folded and connected to the rear end of the vehicle.

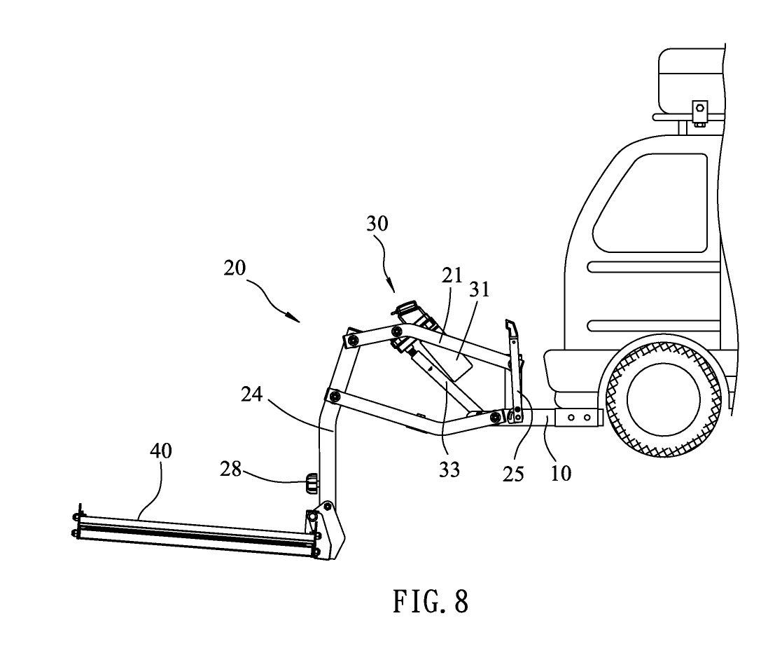

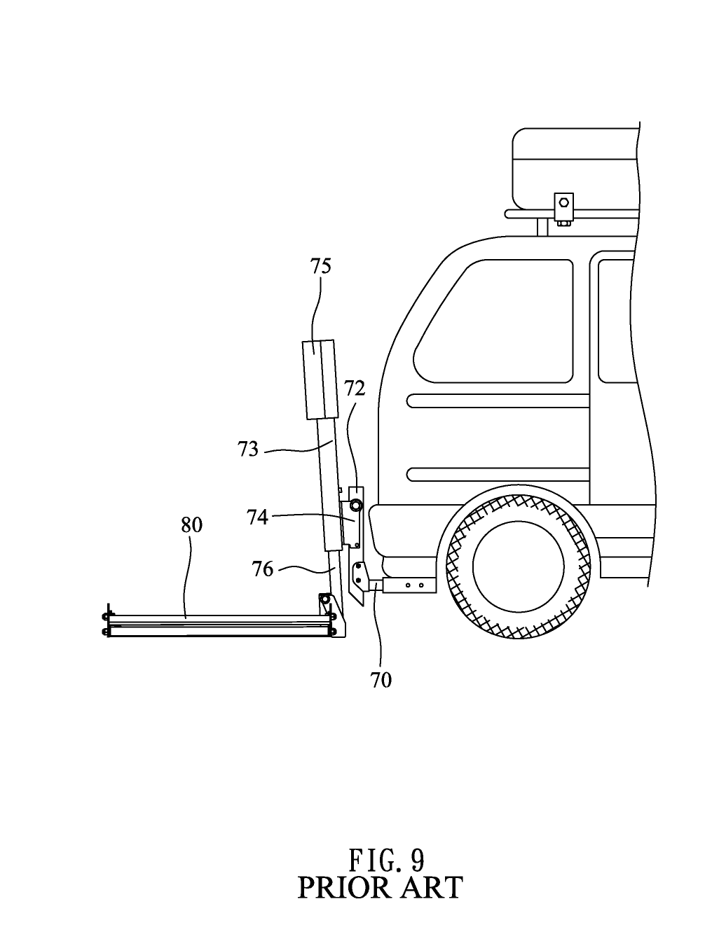

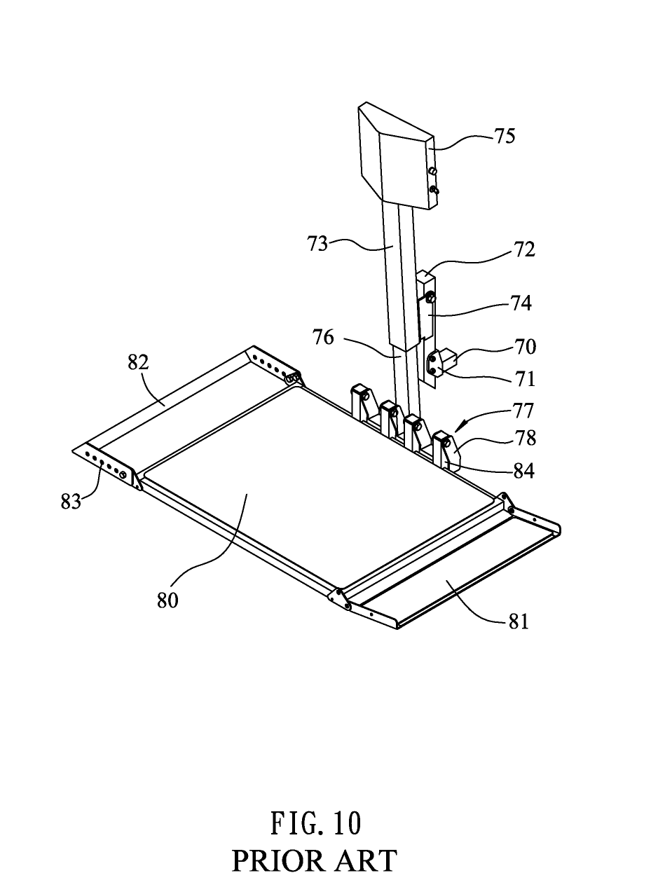

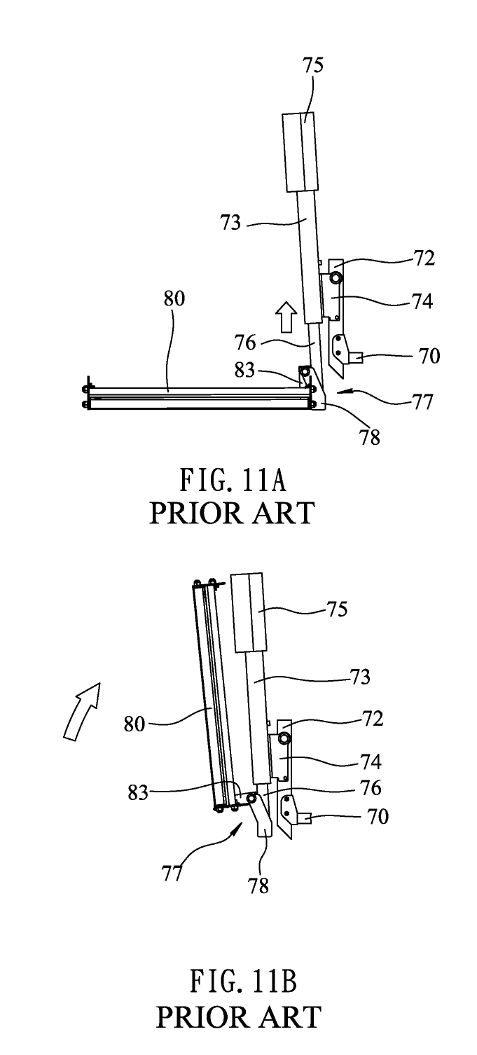

When expanding the electric platform system, the locking member 28 is first removed from the fixing hole 231 of the bridge member 23 and the driving rod 33 is retracted to drive the link unit 20 lower. Because the support board 40 is in contact with the first inclined surface 251 of the stop links 25, so that, with the lowered link unit 20, the support board 40 is pivoted downward along the second inclined surfaces 252. The pin 27 is then removed from the slot 263 of the restriction member 26 and the stop links 25 are pivoted upward, and the pin 27 is then inserted into the positioning hole 262 of the restriction member 26. The driving unit 30 continues to lower the link unit 20 and bring the support board 40 to the ground as shown in FIG. 8. The electric cart 60 can be moved onto the support board 40. The driving unit 30 is then activated again to lift the support link 24 and the support board 40 to a desired height. The electric cart 60 can be carried by the vehicle.

The whole electric platform system can be lowered to a position that is lower then a lower edge of the rear door of the vehicle, such that the rear door can be opened. The electric cart on the support board 40 is located at a distance from the rear door so that the electric cart does not need to be removed when opening the rear door. The first and second inclined surfaces 251, 252 are in contact with the support board 40 in sequence and this assists the pivotal action of the support board 40.

The bridge member 23 is designed to provide a position that the locking member 28 can extend through the support link 24 and be connected to the bridge member 23, such that the support link 24 and the second links 22 are well positioned and the electric platform system is not expanded accidentally.

While we have shown and described the embodiment in accordance with the present invention, it should be clear to those skilled in the art that further embodiments may be made without departing from the scope of the present invention.

What is claimed is:

1. An electric platform system comprising:
a connection member having a first end adapted to be connected to a vehicle and a second end of the connection member connected with a link unit, the link unit including multiple links and a support link, a first end of the link unit connected to the connection member and a second end of the link unit connected with a support board;
a driving unit connected to the link unit and driving the link unit up and down, and
two stop links connected to the connection member and the support board and contacting a side of the support board.

2. The system as claimed in claim 1, wherein the link unit includes two first links, two second links and the support link, the first links are pivotably connected between two sides of the connection member and two sides of the support link, the second links are pivotably connected between the two sides of the connection member and the two sides of the support link.

3. The system as claimed in claim 2, wherein each of the first links includes a first inclined section which is pivotably connected to the support link.

4. The system as claimed in claim 2, wherein each of the second links includes a second inclined section which is pivotably connected to the connection member.

5. The system as claimed in claim 2, wherein the support link includes a third inclined section at one end thereof and the first and second links are connected to the third inclined section.

6. The system as claimed in claim 1, wherein the stop links each have a first inclined surface and a second inclined surface which is located adjacent to the first inclined surface.

7. The system as claimed in claim 1, wherein a restriction member is located between the connection member and one of the stop links, the restriction member includes a positioning hole and a slot defined therethrough, a pin extends through the stop link and is inserted into one of the positioning hole and the slot.

8. The system as claimed in claim 1, wherein the driving unit includes a motor and a driving rod which is driven by the motor and connected to the connection member.

9. The system as claimed in claim 1, wherein two push plates are connected to a side of the support board and the support link is connected to the side of the support board, the push plates are located corresponding to the two stop links.

10. The system as claimed in claim 1, wherein a connection frame is connected between the support link and the support board, the connection frame includes a main part and two end plates are connected on two ends of the main part, multiple connection plates connected to the main part and the support link is pivotably connected between the connection plates, the end plates and the connection plates are pivotably connected to protrusions on the support board.

11. The system as claimed in claim 2, wherein a bridge member is connected between the two second links, a locking member extends through the support link and the bridge member to lock the support link and the link unit when the support board is folded upward.
